(19) United States
(12) Patent Application Publication
(10) Pub. No.: US 2026/0256315 A1
(43) Pub. Date: Sep. 3, 2026

(54) HEAD ASSEMBLY, APPARATUS AND METHOD FOR PREPARING HOT BEVERAGES

(71) Applicants: Nikolai Aleksandrovich KRUTIN, Umraniye/Istanbul (TR); Igor Sergeevich Emelianov, Maltepe/Istanbul (TR)

(72) Inventors: Nikolai Aleksandrovich KRUTIN, Umraniye/Istanbul (TR); Igor Sergeevich Emelianov, Maltepe/Istanbul (TR)

(21) Appl. No.: 19/539,822

(22) Filed: Feb. 13, 2026

(30) Foreign Application Priority Data
Feb. 14, 2025 (TR) 2025/001750

(51) Int. Cl. A47J 31/56; A47J 31/00; A47J 31/46; A47J 31/52

(52) U.S. Cl. CPC A47J 31/56; A47J 31/002; A47J 31/468; A47J 31/5253

(57) ABSTRACT

Provided are a height-adjustable head assembly 20, an apparatus 100 for preparing hot beverages comprising at least one such head assembly 20 being mounted in a counter top 40 and arranged to adjust a height position thereof, and an associated method for preparing hot beverages. The invention proposes the apparatus 100 and method for preparing various hot beverages, wherein the height position of the at least one head 20 assembly is controlled for preparing various hot beverages in a single apparatus.

### FIELD OF THE INVENTION

The invention relates to apparatuses and methods for preparing hot beverages, in particular to an apparatus and a method, wherein a height position of at least one head assembly is controlled for preparing various hot beverages in a single apparatus.

### BACKGROUND

Existing apparatuses for preparing hot beverages, such as coffee, tea, and others, come in various embodiments: a monoblock primarily designed for use in catering establishments, a portable compact device, a countertop-mounted apparatus, or an apparatus containing units located beneath a countertop.

For example, U.S. Pat. No. 11,317,758 B2 (publ. Mar. 05, 2022) teaches a coffee machine, particularly suitable to be used in catering establishments or the like, comprising a machine body provided with a delivering assembly for delivering coffee, at least one boiler designed to heat the water up to the working temperature and means for drawing water from the boiler and supplying the same to the delivering assembly. The boiler is arranged outside of the machine body and remotely therefrom such that the overall dimensions on the working surface are considerably reduced and a simple replacement or interchangeability of the various components is allowed.

An important aspect of operating this and other coffee machines is carefully following the operating mode, specifically, supplying hot water at a specific temperature and pressure for a certain amount of time to prepare the desired beverage. Accordingly, a coffee machine designed for making beverages using an espresso method cannot be used for preparing beverages using a pour-over method, and vice versa.

Known apparatuses do not incorporate any lifting mechanism due to the associated technical challenges. Specifically, the complexity arises from the need to place an additional boiler or other heating means in a head assembly of an apparatus and ensure thermal insulation of a water supply line. Although there are under-counter coffee machines with a main boiler or an additional boiler located in the assembly over the counter, these apparatuses lack moving components, indicating that the issue related to integrating the lifting mechanism into such designs to create a more versatile apparatus for preparing hot beverages remains unresolved.

### SUMMARY OF THE INVENTION

The present invention aims to address at least some of the above-mentioned issues. The technical problem solved by the present invention is to provide an apparatus and method for preparing hot beverages, wherein the height position of at least one head assembly is controlled for preparing various hot beverages in a single apparatus.

In one aspect of the invention, proposed is a height-adjustable head assembly for an apparatus for preparing hot beverages, the head assembly comprising:
a working surface being mountable in a counter top;
a tray being arranged in the working surface;
a hot water temperature control and dispense assembly comprising a heating means and a hot water dispensing means, the hot water temperature control and dispense assembly being arranged on a column in fluid communication with a working assembly of the apparatus; and
a mechanism for adjusting a height position of the head assembly.

In another aspect of the invention, proposed is an apparatus for preparing hot beverages comprising:
a working assembly comprising a working boiler and a pump unit;
at least one head assembly being arranged separately of the working assembly in fluid communication thereto;
a control unit being functionally connected to the working assembly and the at least one head assembly, the control unit is configured to control an operation of the apparatus;
wherein the at least one head assembly is mounted in a counter top and arranged to adjust a height position thereof.

In yet another aspect of the invention, proposed is a method for preparing hot beverages comprising:
selecting an operation mode of at least one head assembly;
by a control unit, controlling a height position of the at least one head assembly;
heating the water according to the selected operation mode;
dispensing the hot water according to the selected operation mode.

The present invention implements a design that allows combining in one apparatus the functions of three different devices: an espresso machine, a pourover-coffee maker and a filter-coffee maker. The apparatus comprises the heating means for preparation and delivery of hot water of a desired temperature, the head assembly including such heating means is configured to be adjustable in height. The boilers of the apparatus have sufficient volume to prepare the required portion of hot water in any of the operation modes. The present technical solution provides versatility and expands the functionality of apparatuses for preparing hot beverages, it improves the level of coffee preparation in specialty coffee shops around the world.

The present invention, in all aspects thereof, enables the preparation of various hot beverages in a single apparatus by a single method. These and other advantages of the invention will be described in more details in the following description.

### BRIEF DESCRIPTION OF THE DRAWINGS

The present invention may be further understood by the following detailed description and drawings in which:

FIG. 1 illustrates a general view of the proposed apparatus;

FIG. 2 illustrates one of preferred embodiments of the proposed apparatus;

FIG. 3 illustrates another preferred embodiment of the proposed apparatus;

FIG. 4 illustrates yet another preferred embodiment of the proposed apparatus;

FIG. 5 illustrates the apparatus in one of operation modes for preparing a hot beverage;

FIG. 6 illustrates the apparatus in another operation mode for preparing a hot beverage;

FIG. 7 illustrates the apparatus in yet another operation mode for preparing a hot beverage;

FIG. 8 illustrates additional embodiments of the proposed apparatus;

FIG. 9 illustrates schematically an exemplary view of the hot water temperature control and dispense assembly of the proposed apparatus;

FIG. 10 illustrates schematically another exemplary view of the hot water temperature control and dispense assembly of the proposed apparatus;

FIG. 11 illustrates a block diagram of the proposed method for preparing a hot beverage.

### DETAILED DESCRIPTION OF THE INVENTION

The invention relates to apparatuses 100 and methods for preparing hot beverages, in particular to an apparatus 10 and a method, wherein a height position of at least one head 20 assembly is controlled for preparing various hot beverages in a single apparatus 100.

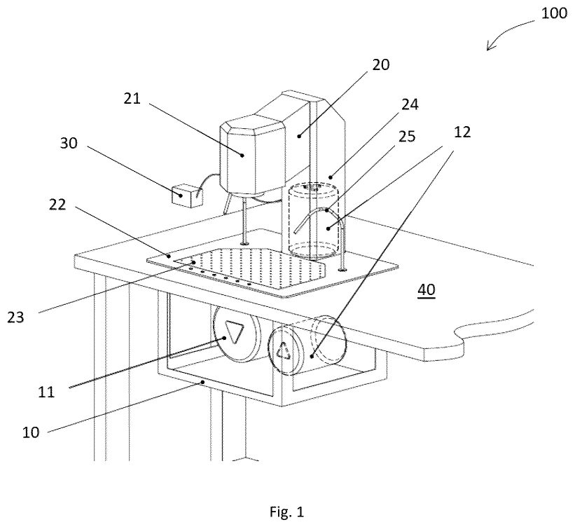

Referring now to the attached drawings, FIG. 1 illustrates a general view of a head assembly and an apparatus 100 for preparing hot beverages comprising the same as proposed in the present invention. The apparatus 100 for preparing hot beverages comprising:
a working assembly 10 comprising a working boiler 11 and a pump unit;
at least one head assembly 20 being arranged separately of the working assembly 10 in fluid communication thereto;
a control unit 30 being functionally connected to the working assembly 10 and the at least one head assembly 20, the control unit 30 is configured to control an operation of the apparatus 100;
wherein the at least one head assembly 20 is mounted in a counter top 40 and arranged to adjust a height position thereof.

Despite the fact that only one head assembly 20 is illustrated in figures it should be understood that more than one head assembly 20 can be arranged and mounted in the counter top 40. In this embodiment, the control unit 30 is functionally connected to the working assembly 10 and each of the head assemblies 20. The control unit 30 is configured to control the operation of the apparatus 100. The above means that the control unit 30 controls the operation of the working assembly 10 and the operation of each of the head assemblies 20.

In the preferred embodiment of FIG. 1, the apparatus 100 comprises only one working assembly 10 being attached to the counter top 40. However, in other embodiments, the apparatus 100 can comprise more than one working assembly 10. In these embodiments, an individual control unit 30 can be provided for operation of each working assembly 10. Alternatively, one and the same control unit 30 can be used to control the operation of the apparatus 10 for preparing hot beverages comprising several working assemblies 10 and/or several head assemblies 20.

Further, proposed in another aspect of the invention is the height-adjustable head assembly 20 for the apparatus 100 for preparing hot beverages, the head assembly 20 comprising:
a working surface 22 being mountable in the counter top 40;
a tray 23 being arranged in the working surface 22;
a hot water temperature control and dispense assembly 21 comprising a heating means and a hot water dispensing means, the hot water temperature control and dispense assembly 21 being arranged on a column 24 in fluid communication with the working assembly 10 of the apparatus 100; and
a mechanism for adjusting the height position of the head assembly 20.

The fluid communication allows to connect the working assembly 10 and the hot water temperature control and dispense assembly 21 via a tube, hose, or the like, preferably thermally insulated to prevent or minimize a heat loss and a drop in water temperature while pumping the water from the working boiler, as it will be described below. Such tubes, hoses, and other means of the fluid communication extend from the working assembly 10 through the column 24 mounted on the countertop 40 and further to the hot water temperature control and dispense assembly 21.

The height position of the head assembly 20 defines a distance between the hot water temperature control and dispense assembly 21 and the tray 23 to accommodate the respective beverage receptacle. The mechanism for adjusting the height position of the head assembly 20 can be designed in different ways, for example, but not limited to, such height adjusting mechanisms like a lifting drive or a lever drive can be used to adjust the height position of the hot water temperature control and dispense assembly 21. Such mechanism can be motorized, i.e., comprising an energized drive, or be handle-actuated.

In other embodiments, the height adjusting mechanism comprises a tray 23 lifting drive to raise and/or lower the tray 23 arranged in the working surface 22 in order to adjust the distance between the hot water temperature control and dispense assembly 21 and the tray 23, as it will be described below. Preferably, the tray lifting drive is motorized, i.e., comprising an energized drive.

Hence, the mechanism for adjusting the height position is configured to adjust the height position of the hot water temperature control and dispense assembly 21 and/or to adjust the height position of the tray 23.

As disclosed above the working assembly 10 comprises the working boiler 11 and the pump unit. The pump unit is not illustrated in figures, but it should be understood that it is necessary to pump the hot water through the apparatus, i.e., for drawing water from the working boiler 11 and supplying the same to the head assembly 20. The head assembly 20 comprises the heating means arranged in the hot water temperature control and dispense assembly 21 fluidically close to the hot water dispensing means. The above arrangement is preferable, since the delivering hot water at precise temperature is crucial for the quality of the beverage to be dispensed.

In the preferred embodiment of the invention described below, the heating means comprises a head boiler. However, it should be understood that the heating means can comprise a flow heater, or a combination thereof. As it was mentioned, the precise temperature of the hot water is crucial for the quality of the beverage, thus, the head boiler, or the flow heater, or both of them are configured to provide the hot water at exactly desired temperature in accordance with the selected operation mode as it will be described below. It should be understood, that the apparatus 100 is provided with a temperature sensor or multiple temperature sensors to detect the temperature of the hot water to be dispensed.

In the preferred embodiment, the apparatus 100 for preparing hot beverages can comprise an additional boiler 12 (illustrated by the dotted lines in FIG. 1), which can be arranged either in the working assembly 10 or in the head assembly 20. For example, as illustrated in FIG. 1, the additional boiler 12 can be arranged in the column 24 of the head assembly 20.

The working boiler 11 may be further referred to as a steam and hot water boiler. For example, the working boiler 11 can have a volume of 5 liters, among other possible capacities. The additional boiler 12 may be further referred to as a coffee boiler. For example, the additional boiler 12 can have a volume of 4 to 6 liters, among other possible capacities. The head boiler is for precise control of temperature of the beverages to be dispensed. For example, the head boiler can have a volume of 500-1000 ml, among other possible capacities. The head boiler is beneficial for delivering the hot water to the hot water dispensing means at a desired temperature without or substantially without temperature fluctuations and losses. The same advantageous effect can be achieved with the flow heater, either alone or in combination with the head boiler, when arranged in the hot water temperature control and dispense assembly.

All the boilers are heated with individual heaters, for example, working at 220V and a single phase. In normal operation, the hot water from the working boiler 11 is supplied to the additional boiler 12, which maintains or additionally heats the water. The water from the additional boiler 12 is then supplied to the head boiler, which maintains or additionally heats the water to the desired temperature to dispense it through the hot water dispensing means.

It should be understood that, in the described above embodiment, where the apparatus 100 comprises the additional boiler 12, the control unit 30 being functionally connected to the working assembly 10 and the at least one head assembly 20 is further connected to the additional boiler 12. Hence, the control unit 30 is configured to control an operation of the apparatus 100 including three boilers (the working boiler 11, the additional boiler 12 and the head boiler).

As shown in FIGS. 1-7, the apparatus 100 for preparing hot beverages can comprise a first steam wand 25 and/or a second steam wand 26. In the preferred embodiment, the steam wand is a cool touch steam wand to avoid harness of the operator (i.e. barista). The first steam wand 25 and the second steam wand 26 are in fluid communication with the working boiler 11 and/or with the additional boiler 12, if presented.

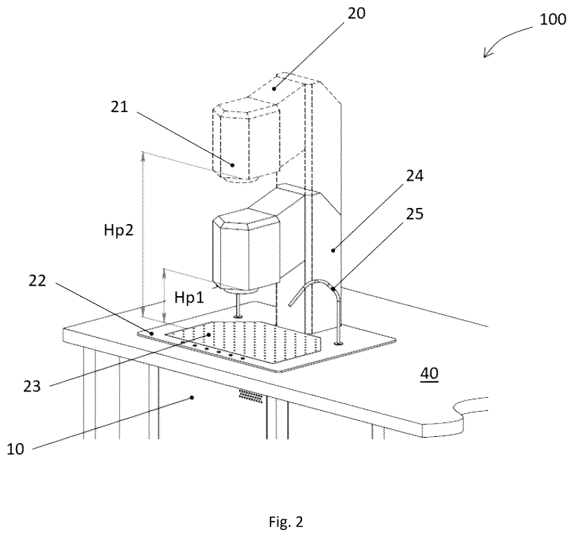

Turning now to FIG. 2, the proposed apparatus 100 comprising the head assembly 20 is shown in two possible height positions. The first height position Hp1 is characterized by the shortest distance between the tray 23 of the working surface 22 and the hot water temperature control and dispense assembly 21 of the head assembly 20. The second height position Hp2 is characterized by the longest distance between the tray 23 of the working surface 22 and the hot water temperature control and dispense assembly 21 of the head assembly 20.

It should be understood that in the illustrated embodiment of FIG. 2 the mechanism for adjusting the height position of the head assembly 20 is preferably a lifting drive configured to adjust the height position of the hot water temperature control and dispense assembly 21 relative to the tray 23 of the working surface 22.

Despite the fact that only two height positions characterized by the shortest distance Hp1 and the longest distance Hp2 are illustrated in FIG. 2, the height position of the hot water temperature control and dispense assembly 21 can be continuously adjusted and chosen depending on the beverage to be prepared, as it will be described below.

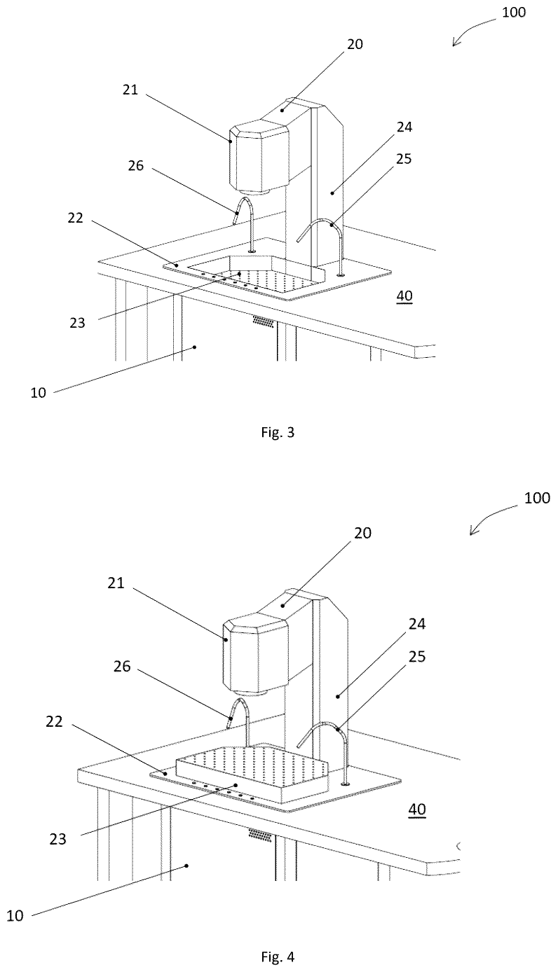

Turning now to FIG. 3, the proposed apparatus 100 comprising the head assembly 20 is shown in the working position where the tray 23 of the working surface 22 is lowered, by the tray lifting drive, relative to the level of the working surface 22. It should be understood that in the illustrated embodiment of FIG. 3 the mechanism for adjusting the height position of the head assembly 20 is configured to adjust the height position of the tray 23 of the working surface 22 relative to the hot water temperature control and dispense assembly 21, i.e. allowing to place the beverage receptacles of different sizes, as it will be described below.

Turning now to FIG. 4, the proposed apparatus 100 comprising the head assembly 20 is shown in the working position where the tray 23 of the working surface 22 is raised, by the tray lifting drive, relative to the level of the working surface 22. It should be understood that in the illustrated embodiment of FIG. 4 the mechanism for adjusting the height position of the head assembly 20 is configured to adjust the height position of the tray 23 of the working surface 22 relative to the hot water temperature control and dispense assembly 21, i.e. allowing to place the beverage receptacles of different sizes, as it will be described below.

It should be understood that the embodiments of FIGS. 3 and 4 can be combined allowing to lower and raise the tray 23 of the working surface 22 relative to the level of the working surface. In this preferred embodiment, the mechanism for adjusting the height position of the head assembly 20 is configured to adjust the height position of the tray 23 of the working surface 22 relative to the hot water temperature control and dispense assembly 21, i.e. allowing to place the beverage receptacles of different sizes, as it will be described below.

Moreover, in some other embodiments, the mechanism for adjusting the height position of the head assembly 20 can be configured to adjust the height position of the tray 23 of the working surface 22 as well as the height position of the hot water temperature control and dispense assembly 21 relative to each other, i.e. allowing to adjust the height position of the head assembly in wide range and allowing to place the beverage receptacles of different sizes, as it will be described below.

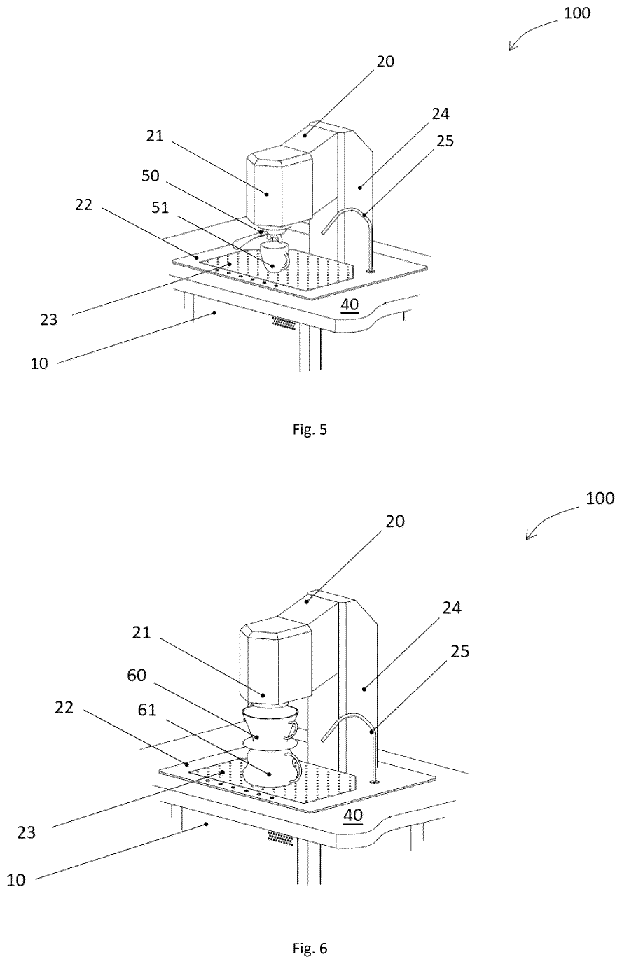

Now turning to FIGS. 5-7, where the proposed apparatus 100 for preparing hot beverages comprising the head assembly 20 is shown in the different height positions corresponding to different operation modes. In the embodiment illustrated in FIGS. 5-7, the mechanism for adjusting the height position of the head assembly 20 is configured to adjust the height position of the hot water temperature control and dispense assembly 21 relative to the tray 23 of the working surface 22 as it was described above with the reference to FIG. 2. However, it should be understood that the mechanism for adjusting the height position of the head assembly 20 can be configured to adjust the height position of the tray 23 of the working surface 22 as it was described with reference to FIGS. 3-4. Alternatively, the mechanism for adjusting the height position of the head assembly 20 can comprise a combination of the drives described with reference to FIGS. 2-4.

To be more precise, FIG. 5 illustrates the head assembly 20 in the lowest position thereof, i.e. in the height position where the distance between the tray 23 and the hot water temperature control and dispense assembly 21 is the shortest. In general, this distance is substantially enough for a portafilter 50 to be attached to the hot water temperature control and dispense assembly 21 and an espresso cup 51 (a glass shot or the like) to be located on the tray under the portafilter 50. Thus, the illustrated height position is preferred to prepare the shot of espresso coffee.

FIG. 6 illustrates the head assembly 20 in the middle position thereof, i.e. in the height position where the distance between the tray 23 and the hot water temperature control and dispense assembly 21 is between the shortest and the longest ones. In general, this distance is substantially enough to accommodate a first filter cone 60 and a first beverage receptacle 61 (such as a small kettle or a mug, for example). Thus, the illustrated height position is preferred to prepare the portion of the pour-over coffee.

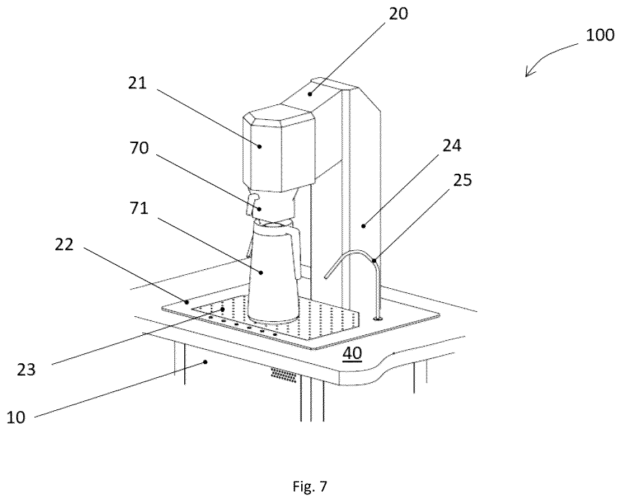

FIG. 7 illustrates the head assembly 20 in the highest position thereof, i.e. in the height position where the distance between the tray 23 and the hot water temperature control and dispense assembly 21 is the longest. In general, this distance is substantially enough to accommodate a second filter cone 70 and a second beverage receptacle 71 suitable for a large batch (such as a thermos bottle or a big kettle, for example). Thus, the illustrated height position is preferred to prepare the batch-brew coffee.

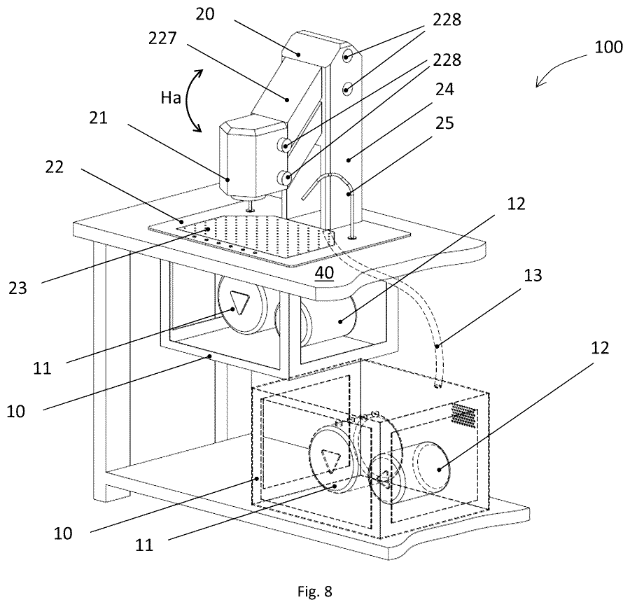

Now turning to the FIG. 8, where another embodiment of the apparatus 100 for preparing hot beverages is illustrated. The elements, assemblies and units of the apparatus 100 are substantially the same as in the apparatus 100 for preparing hot beverages discussed above. The apparatus 100 for preparing hot beverages comprising:
a working assembly 10 comprising a working boiler 11 and a pump unit;
at least one head assembly 20 being arranged separately of the working assembly 10 in fluid communication thereto;
a control unit (not shown in FIG. 8) being functionally connected to the working assembly 10 and the at least one head assembly 20, the control unit is configured to control an operation of the apparatus 100;
wherein the at least one head assembly 20 is mounted in a counter top 40 and arranged to adjust a height position thereof.

In the preferred embodiment, the apparatus 100 comprises the working assembly 10 being attached to the counter top 40. However, in another embodiment, the apparatus 100 can comprise the working assembly 10 (shown in dotted lines) arranged separately of the counter top 40. A tube 313 is shown in dotted lines to illustrate the fluid communication between the working assembly 10 and the head assembly 20.

The height-adjustable head assembly 20 of the apparatus 100 for preparing hot beverages comprises:
a working surface 22 being mountable in the counter top 40;
a tray 23 being arranged in the working surface 22;
a hot water temperature control and dispense assembly 21 comprising a heating means and a hot water dispensing means, the hot water temperature control and dispense assembly 21 being arranged on a column 24 in fluid communication with the working assembly 20 (provided separately of the counter top 40 or attached to the counter top 40) of the apparatus 100; and
a mechanism for adjusting the height position of the head assembly 20.

The apparatus 100 for preparing hot beverages can further comprise a first steam wand 25. In the preferred embodiment, the first steam wand 25 is a cool touch steam wand to avoid harness of the operator (i.e. barista). The first steam wand 25 is in fluid communication with the working boiler 11 and/or with the additional boiler 21, if presented. It should be understood that the above description of the additional boiler 12 may refer to the additional boiler 12 within the working assembly 10 that is provided separately of the counter top 40 or attached to the counter top 40 arranged in the apparatus 100 illustrated in FIG. 8.

In the illustrated embodiment of FIG. 8, the mechanism for adjusting the height position of the head assembly 20 comprises a lever drive that is used to adjust the height position of the head assembly 20, i.e. to continuously control the distance between the hot water temperature control and dispense assembly 21 and the tray 23 to accommodate the respective beverage receptacle.

The column 24 of the head assembly comprises connection means or pivotable elements 228 (such as a rode or a pin, for example). The hot water temperature control and dispense assembly 21 comprises other connection means or pivotable elements 228 (such as a rode or a pin, for example). At least one lever or arm 227 is provided to connected the column 24 and the hot water temperature control and dispense assembly 21 through the corresponding pivotable elements 228. The described mechanism allows to adjust the height position Ha of the head assembly 20 by raising and lowering the hot water temperature control and dispense assembly 21.

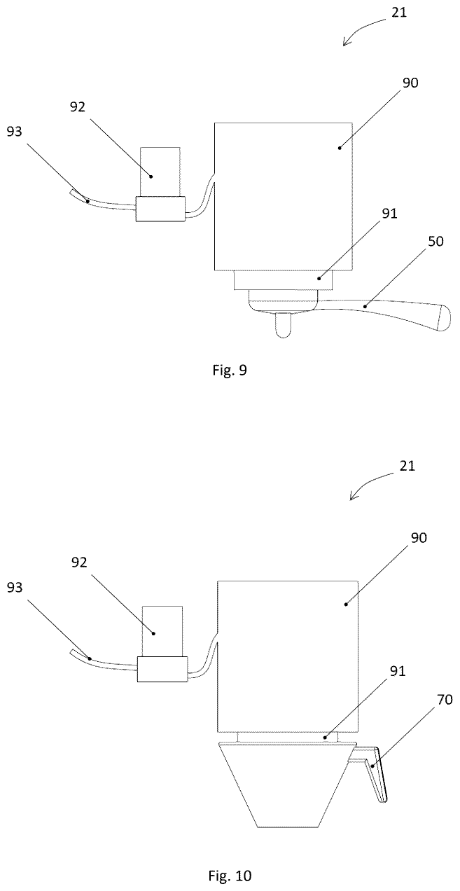

Now turning to FIG. 9 and FIG. 10, illustrated is the preferred embodiment of the hot water temperature control and dispense assembly 21 comprising at least one head boiler 90 and a hot water dispensing means 91. As described above, the hot water temperature control and dispense assembly 21 is arranged on a column in fluid communication with the working assembly of the apparatus. The hot water dispensing means 91 is configured to accommodate either the portafilter 50 or the second filter cone 70. In the further embodiment, the adaptor (not shown) can be used to attach the second filter cone 70 to the hot water dispensing means 91.

Further, with reference to FIGS. 9-10, the hot water temperature control and dispense assembly 21 comprises a control valve 92 and a drain tube 93 in fluid communication with the tray 23. The above arrangement allows for the rapid change of operation mode and the preparation of different types of beverages one after another.

Further, the hot water dispensing means 91 can comprise the sensor allowing to detect whether the portafilter 50 or the second filter cone 70 is attached thereto. The signal from the sensor can be used to additionally control and/or confirm the operation mode of the head assembly 20.

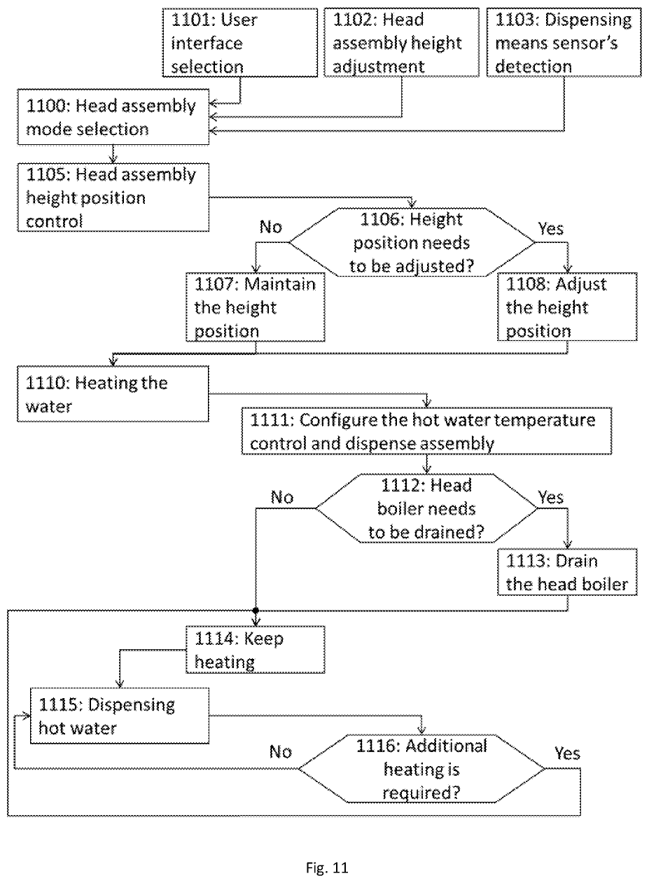

FIG. 11 schematically illustrates the block diagram of a method for preparing hot beverages according to another aspect of the invention, the method comprising:
Step 1100—selecting an operation mode of at least one head assembly 20;
Step 1105—by a control unit 30, controlling a height position of the at least one head assembly 20;
Step 1110—heating the water according to the selected operation mode;
Step 1115—dispensing the hot water according to the selected operation mode.

The control unit 30 can comprise a controller and a memory storing program code. The controller is configured to execute the proposed method based on the program code. The memory may also store predefined parameters for the operation modes, which enable the control unit to adjust the operation of the apparatus 100 according to the specified settings and conditions.

The control unit 30 of the apparatus 100 can comprise the user interface, or be connected to the user interface. The operator (i.e. barista) may select the required operation mode using the said user interface at step 1101 of the proposed method. To be more precise, the operator may directly select the operation mode of the head assembly 20 or select the beverage to be brewed, including temperature, volume, and pressure of hot water to be dispensed, time of dispensing and other parameters defining the recipe of the beverage to be brewed. In response to the selection, the control unit 30 sets the desired height position of the head assembly 20 and other required parameters.

The user interface can be selected from any suitable means, such as a touchscreen, button controller, rotary controller, and others. The user interface can be integrated into the housing of the head assembly 20 (the hot water temperature control and dispense assembly 21 or the column 24), the counter top 40, the working surface 22, or be an external user device connected to the control unit of the proposed apparatus via wired or wireless communication. In additional embodiments, the control unit 30 may include a wireless communication module (IR, Bluetooth, WiFi, etc.) to receive instructions from a remote device, such as a specialized remote control, mobile phone, and others.

Alternatively, the head assembly 20 can be configured to be adjusted in height manually. In other words, the operator (i.e. barista) may adjust the height position of the head assembly 20 at step 1102 of the proposed method. In response to the adjusted height position of the head assembly 20, the control unit 30 can determine the desired operation mode. For example, the lowest position of the head assembly 20 corresponds to Mode 1 (also referred to as “Espresso mode”). The middle position of the head assembly 20 corresponds to Mode 2 (also referred to as “Pour-over mode” or “V60 mode”). The highest position of the head assembly 20 corresponds to Mode 3 (also referred to as “Batch brew mode”). To facilitate the head assembly 20 selection mode by manual adjustment the height adjusting mechanism of the head assembly 20 can be configured to remain fixed in one of the above three positions while allowing for easier movement between these positions.

In further alternative, the operation mode of the at least one head assembly 20 is selected by attaching a beverage preparing means to a hot water dispensing means 91 at step 1103 of the proposed method. As described above, the hot water dispensing means 91 can comprise the sensor allowing to detect whether the portafilter 50 or the second filter cone 70 is attached thereto. In response to the signal from the above sensor, the control unit 30 can determine the desired operation mode. For example, in response to the signal indicating that the portafilter 50 is attached, the control unit 30 selects Mode 1 “Espresso mode” for the head assembly operation. In response to the signal indicating that the second filter cone 70 is attached, the control unit 30 selects Mode 3 “Batch brew mode” for the head assembly operation.

Further, the signal from the above sensor can be used to confirm the operation mode of the apparatus 100. For example, if the signal indicates that the portafilter 50 is attached, and the height position of the head assembly 20 corresponds to Mode 2 or Mode 3, the control unit 30 provides a caution signal to the operator (i.e. barista), for example, through the user interface or a separate display or screen or indicator that can be arranged in the apparatus 100. In the same way, if the signal indicates that the second filter cone 70 is attached, and the height position of the head assembly corresponds to Mode 1 or Mode 2, the control unit 30 provides a caution signal to the operator (i.e. barista), for example, through the user interface or the separate display or screen or indicator.

The above-mentioned Mode 1, Mode 2, Mode 3 are discussed below in more details.

Mode 1, or “Espresso mode” (see FIG. 5). The following operation parameters are selected. Brewing temperature: 88-96° C., Brewing Pressure: 8-10 bar, Extraction Time: 20-30 seconds, Coffee Dose: 7-18 g (single or double shot), Water Volume: 25-60 ml. A pre-infusion water weight and/or volume and a pre-infusion time, a final weight of a beverage at which the apparatus stops can be further selected. The pressure profile can be comprised of two steps, including a short dispensing step at relatively low pressure (for example, 1 to 2 bar), and a long dispensing step at high pressure (between 8 to 10 bar). The head assembly 20 should be positioned at the lowest height position, i.e. defining the shortest distance between the hot water temperature control and dispense assembly 21 and the tray 23. A high-pressure pump forces heated water through finely ground coffee at a controlled flow rate, producing a concentrated coffee beverage with a characteristic crema layer.

Mode 2, or “Pour-over mode” or “V60 mode” (see FIG. 6). The following operation parameters are selected. Water Temperature: 90-96° C., Brewing Pressure: 0 bar (substantially gravity-fed), Extraction Time: 2-4 minutes, Coffee Dose: 15-30 g, Water Volume: 200-500 ml. A pre-infusion water weight and/or volume and a pre-infusion time, a number of pre-infusions (up to 3 of them), a final weight of a beverage at which the apparatus stops can be further selected, preferably but not limited to around 200-500 ml, alternatively, up to 1 liter. The flow profile can be comprised of several steps, including a short dispensing step at normal flow rate (for example, 8-15 ml/sec), and a long dispensing step at low flow rate (between 3 to 8 ml/sec). The head assembly 20 should be positioned at the middle height position, i.e. defining the middle distance between the hot water temperature control and dispense assembly 21 and the tray 23. The apparatus 100 dispenses heated water in a controlled manner over a coffee bed, using a pulsed or continuous flow profile to achieve even saturation and optimal extraction.

Mode 3, or “Batch brew mode” (see FIG. 7). The following operation parameters are selected. Water Temperature: 88-94° C., Brewing Pressure: 0 bar (substantially gravity-fed), Extraction Time: 4-6 minutes, Coffee Dose: 50-70 g per liter, Water Volume: 500-3000 ml. A pre-infusion water weight and/or volume and a pre-infusion time, a number of pre-infusions (up to 3 of them), a final weight of a beverage at which the apparatus 100 stops can be further selected, preferably up to 3 liters. The head assembly 20 should be positioned at the highest height position, i.e. defining the longest distance between the hot water temperature control and dispense assembly 21 and the tray 23. Water is dispensed gradually over medium-ground coffee in the filter cone, allowing controlled percolation through the coffee bed to produce a balanced and less acidic brew.

As a result of the operation mode selection at step 1100 the control unit 30 determines the desired height position of the head assembly 20 as described above.

Next, at step 1105, the control unit 30 controls the head assembly height position. To be more precise, the control unit 30 detects whether the current height position of the head assembly 20 is different from the height position determined at step 1100. The control unit 30 has an input signal indicating the current height position (or previous operating height position) of the head assembly 20. The control unit 30 further receives another input signal indicating the desired height position, which is determined at step 1100 of the method either through the user interface (step 1101) or by manually adjusting the assembly (step 1102). Next, at step 1106, the control unit 30 determines whether the current height position and the desired height position are the same or different, i.e. the control unit 30 determines whether the height position of the head assembly 20 needs to be changed or not.

If, at step 1106, the difference between the current height position and the desired height position was not detected, then, at step 1107, the height position of the head assembly 20 is maintained, otherwise, at step 1108, the control unit 30 instructs the mechanism for adjusting the height position of the head assembly 20 to adjust the height position of the head assembly 20 correspondingly and bring it in the desired height position that was determined at step 1100. Alternatively, at step 1108, the control unit 30 provides an informational signal or an instruction to the operator (i.e. barista) indicating that the height position of the head assembly 20 should be adjusted, for example, through the user interface or a separate display or screen or indicator that can be arranged in the apparatus.

Next, at step 1110, the proposed apparatus 100 heats the water to the desired temperature that corresponds to the selected mode. To be more precise, at step 1111, the control unit 30 configures the hot water temperature control and dispense assembly. For example, if the selected mode requires, the heating means of the hot water temperature control and dispense assembly are activated to provide the hot water to be dispensed at the precise temperature.

Next, if the hot water temperature control and dispense assembly is provided with the head boiler, then, at step 1112, the control unit detects whether the temperature of the hot water to be dispensed in the head boiler is higher than the desired temperature determined at step 1100. If so, the head boiler needs to be drained in order to reheat the water at the desired temperature which is lower than the current water temperature in the head boiler. If, at step 1112, it was detected that the head boiler should be drained, then, at step 1113, the control unit instructs the control valve in the hot water temperature control and dispense assembly to drain the hot water through the drain tube, otherwise, at step 1114, the boilers are instructed to keep heating the water or maintain the temperature. It should be understood that the apparatus 100 comprises temperature sensors to detect the temperature of the water in the boilers and in the dispensing means.

As soon as the water in the boilers of the apparatus 100 reaches the desired temperature, the apparatus, at step 1115, dispenses the hot water through the dispensing means of the hot water temperature control and dispense assembly 21. If the selected operation mode requires, then, at step 1116, the control unit 30 determines whether additional heating is required or not. The control unit 30 can determine that the additional heating is required after the predetermined time (for example, in Mode 2 or Mode 3) or in case the hot water temperature control and dispense assembly detects that the temperature drops below the desired temperature (in any operation mode). In accordance with the instructions executed by the control unit, the method proceeds back to step 1114 to additionally heat the water to be dispensed. After the predetermined period of time of dispensing in accordance with the selected operation mode the apparatus 100 stops. The beverage is ready, the apparatus 100 is ready for the next selection of the operation mode and a new beverage.

As it was described, the present invention, in all aspects thereof, enables the preparation of various hot beverages in a single apparatus by a single method. Although the description discloses the use of the apparatus 100 and the associated method for preparing coffee beverages, a person skilled in the art will understand that the proposed apparatus, due to the presence of a height-adjustable head assembly allowing to dispense hot water in different operation modes, can be used for preparing other hot beverages such as tea, hot chocolate, herbal infusions, matcha, chai latte, and other similar drinks.

Embodiments of the invention are not limited to the embodiments described herein. Other embodiments of the invention that do not depart from the essence and scope of this invention will become apparent to those skilled in the art based on the information provided in this description and their technical knowledge.

Elements indicated in the singular form do not exclude the presence of multiple elements unless explicitly stated otherwise.

A functional connection between elements refers to a connection that ensures proper interaction of these elements with each other and the implementation of certain functionalities. Specific examples of functional connections may include connections enabling the exchange of information, the transmission of electric current, mechanical motion, light, sound, electromagnetic, or mechanical vibrations, etc. The specific type of functional connection is determined by the nature of the interaction between the mentioned elements and, unless otherwise stated, is implemented using widely known means based on commonly known technical principles.

The application does not specify particular software or hardware for the implementation of the elements and units shown in the drawings, only some exemplary embodiments are mentioned. It should be understood by those skilled in the art that the essence of the invention is not limited to a specific software or hardware implementation. Therefore, any software and hardware means known in the art may be used to implement the invention. For instance, hardware can be implemented in one or more specialized integrated circuits, digital signal processors, digital signal processing devices, programmable logic devices, field-programmable gate arrays, processors, controllers, microcontrollers, microprocessors, electronic devices, other electronic modules capable of performing the functions described herein, a computer, or combinations thereof.

Although exemplary embodiments have been described in detail and illustrated in the accompanying drawings, it should be understood that these embodiments are merely illustrative and are not intended to limit the broader invention. The invention should not be restricted to the specific layouts and designs shown and described, as various other modifications may be apparent to those skilled in the relevant field.

Features disclosed in different dependent claims, as well as implementations disclosed in various parts of the description, may be combined to achieve beneficial effects, even if the possibility of such combinations is not explicitly disclosed.

1. A height-adjustable head assembly 20 for an apparatus 100 for preparing hot beverages, the head assembly 20 comprising:
a working surface 22 being mountable in a counter top 40;
a tray 23 being arranged in the working surface 22;
a hot water temperature control and dispense assembly 21 comprising a heating means and a hot water dispensing means, the hot water temperature control and dispense assembly 21 being arranged on a column 24 in fluid communication with a working assembly 10 of the apparatus 100; and
a mechanism for adjusting a height position Ha of the head assembly 20.

2. The head assembly 20 of claim 1, wherein the mechanism for adjusting the height position comprises a lifting drive or a lever drive configured to adjust the height position of the hot water temperature control and dispense assembly 21.

3. The head assembly 20 of claim 1, wherein the mechanism for adjusting the height position comprises a tray lifting drive to adjust the height position of the tray 23.

4. The head assembly 20 of claim 1, wherein the heating means comprises a head boiler, a flow heater, or a combination thereof.

5. An apparatus 100 for preparing hot beverages comprising:
a working assembly 10 comprising a working boiler 11 and a pump unit;
at least one head assembly 20 being arranged separately of the working assembly 10 in fluid communication thereto;
a control unit 30 being functionally connected to the working assembly 10 and the at least one head assembly 20, the control unit 30 is configured to control an operation of the apparatus 100;
wherein the at least one head assembly 20 is mounted in a counter top 40 and arranged to adjust a height position thereof.

6. The apparatus 100 of claim 5, wherein the working assembly 10 being attached to the counter top 40 or arranged separately thereof.

7. The apparatus 100 of claim 5, wherein the head assembly 10 comprises a working surface 22 being mountable in the counter top 40; a tray 23 being arranged in the working surface 22; a hot water temperature control and dispense assembly 21 comprising a heating means and a hot water dispensing means, the hot water temperature control and dispense assembly 21 being arranged on a column 24 in fluid communication with the working assembly of the apparatus 100; and a mechanism for adjusting the height position of the head assembly 20.

8. A method for preparing hot beverages comprising:
selecting an operation mode of at least one head assembly 20;
by a control unit 30, controlling a height position of the at least one head assembly 20;
heating the water according to the selected operation mode;
dispensing the hot water according to the selected operation mode.

9. The method of claim 8, wherein the operation mode of the at least one head assembly 20 is selected through a user interface.

10. The method of claim 8, wherein the operation mode of the at least one head assembly 20 is selected by adjusting manually the height position of the at least one head assembly 20.
